(19) United States
(12) Patent Application Publication
(10) Pub. No.: US 2021/0201666 A1
(43) Pub. Date: Jul. 1, 2021

(54) SCALABLE AND DISTRIBUTED DETECTION OF ROAD ANOMALY EVENTS

(71) Applicant: OATH INC., New York, NY (US)

(72) Inventors: Dan PELLEG, Haifa (IL); Ran WOLFF, Geva Carmel (IL)

(21) Appl. No.: 16/731,379

(22) Filed: Dec. 31, 2019

(51) Int. Cl. G08G 1/01; G01C 21/32; H04W 4/44

(52) U.S. Cl. CPC G08G 1/0141; G01C 21/32; H04W 4/44; G08G 1/0133; G08G 1/0112

(57) ABSTRACT

Systems, devices, and methods for the scalable and distributed detection of road anomaly events are disclosed. In one embodiment, the system comprises a sensor monitor configured to: receive data regarding road anomaly events detected by a plurality of sensors through a communication network; analyze the received data; identify a subset road anomaly events based on analyzing the received data; determine the size of the subset of road anomaly events exceeds a pre-defined threshold; and in response to determining the size of the subset of road anomaly events exceeds a pre-defined threshold, perform at least one action.

### COPYRIGHT NOTICE

This application includes material that may be subject to copyright protection. The copyright owner has no objection to the facsimile reproduction by anyone of the patent disclosure, as it appears in the Patent and Trademark Office files or records, but otherwise reserves all copyright rights whatsoever.

### BACKGROUND

### Technical Field

The disclosed embodiments describe systems, devices, methods, and computer-readable media for detecting road anomaly events, and more particularly, but not limited to, scalable and distributed detection of road anomaly events by vehicles.

### Description of the Related Art

Currently, vehicles use a variety of sensors to detect road anomaly events and to analyze the changing environment around the vehicle during travel. Road anomaly events include potholes, road bumps, sudden swerves, emergency brakes, cargo falling off trucks, etc. Failing to detect certain of these road anomaly events could cause unexpected or undesired behavior of the vehicle. It could expose passengers of the vehicle or others outside of the vehicle (e.g., in the immediate area surrounding the vehicle) to danger.

In some cases, an object may be positioned in a way that creates an unsafe driving condition (e.g., a deep pothole in the center of a road, cargoes falling off trucks). Failure by a driver or a vehicle computing system to detect the unsafe condition may create a physical danger of injury to the driver or other passengers of a vehicle (e.g., a vehicle that suddenly encounters a deep pothole or other unsafe road condition without warning).

The disclosed embodiments describe systems, devices, computer-readable media, and methods that remedy these and other problems.

### SUMMARY

The disclosed embodiments describe a technical solution for detecting road anomaly events. In one embodiment, a method is disclosed comprising receiving, by a processor, data regarding potential road anomaly events detected by a plurality of sensors in a communication network; identifying, by the processor, a subset of the road anomaly events, each event in the subset of road anomaly events associated with a confidence level exceeding a pre-defined threshold; identifying, by the processor, a confirmed road anomaly event based on the subset of road anomaly events; and sending, by the processor, at least one communication associated with the confirmed road anomaly event to a computing device based on a type of the confirmed road anomaly event.

In another embodiments, a device is disclosed comprising a processor; and a storage medium for tangibly storing thereon program logic for execution by the processor, the stored program logic comprising logic for receiving, by the processor, data regarding potential road anomaly events detected by a plurality of sensors in a communication network; logic for identifying, by the processor, a subset of the road anomaly events, each event in the subset of road anomaly events associated with a confidence level exceeding a pre-defined threshold; logic for identifying, by the processor, a confirmed road anomaly event based on the subset of road anomaly events; and logic for sending, by the processor, at least one communication associated with the confirmed road anomaly event to a computing device based on a type of the confirmed road anomaly event.

In another embodiments, a non-transitory computer-readable storage medium is disclosed for tangibly storing computer program instructions capable of being executed by a computer processor, the computer program instructions defining the steps of: receiving, by the processor, data regarding potential road anomaly events detected by a plurality of sensors in a communication network; identifying, by the processor, a subset of the road anomaly events, each event in the subset of road anomaly events associated with a confidence level exceeding a pre-defined threshold; identifying, by the processor, a confirmed road anomaly event based on the subset of road anomaly events; and sending, by the processor, at least one communication associated with the confirmed road anomaly event to a computing device based on a type of the confirmed road anomaly event.

### BRIEF DESCRIPTION OF THE FIGURES

The preceding and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure.

FIG. 1 is a block diagram illustrating a system for receiving data regarding road anomaly events occurring on a plurality of vehicles according to some embodiments of the disclosure.

FIG. 2 is a flow diagram illustrating a method for identifying road anomaly events according to some embodiments of the disclosure.

FIG. 3 is a flow diagram illustrating a method for identifying road anomaly events according to some embodiments of the disclosure.

FIG. 4 is a flow diagram illustrating a method for receiving and classifying road anomaly events based on the type of each road anomaly event according to some embodiments of the disclosure.

FIG. 5 is a block diagram illustrating a vehicle controlled or configured via a communication interface using a cloud service according to some embodiments of the disclosure.

FIG. 6 is a block diagram of a vehicle including one or more various components or subsystems, each of which can be updated in various embodiments to configure the vehicle or perform other actions associated with the vehicle.

### DETAILED DESCRIPTION

The present disclosure will now be described more fully in the descriptions of the accompanying drawings, which form a part hereof, and which show, by way of illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. Also, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. Also, the term “based on” may be understood as not necessarily intended to convey an exclusive set of factors and may, instead, allow for the existence of additional factors not necessarily expressly described, again, depending at least in part on context.

The present disclosure is described below in the descriptions of block diagrams and operational illustrations of methods and devices. Each block of the block diagrams or operational illustrations, and combinations of blocks in the block diagrams or operational illustrations can be implemented using analog or digital hardware and computer program instructions. These computer program instructions can be provided to a processor of a general-purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

These computer program instructions can be provided to a processor of: a general purpose computer to alter its function to a special purpose; a special purpose computer; ASIC; or other programmable digital data processing apparatus, such that the instructions, which execute via the processor of the computer or other programmable data processing apparatus, implement the functions/acts specified in the block diagrams or operational block or blocks, thereby transforming their functionality in accordance with embodiments herein.

For this disclosure a computer readable medium (or computer-readable storage medium/media) stores computer data, which data can include computer program code (or computer-executable instructions) that is executable by a computer, in machine-readable form. By way of example, and not limitation, a computer readable medium may comprise computer-readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

Currently, the technology supporting vehicles continues to improve. Improvements in digital camera technology, light detection and ranging (LIDAR), and other technologies have enabled vehicles to navigate roadways independent of drivers or with limited assistance from drivers.

While computerized vehicle technology focuses on controlling the movement of vehicles in a traditional sense, little emphasis has been placed on alternative applications that may be implemented on top of these computerized systems. Indeed, application-level systems generally tend to reinforce existing uses of vehicular systems.

However, these approaches fail to fully utilize the hardware and processing power being implemented in vehicles, or in other vehicles utilizing automated driver assistance systems. Thus, there currently exists a need in the state of the art of vehicular computing systems to provide additional services leveraging the existing hardware installed within such vehicles.

In particular, there is a need to solve the technical problem of detecting unsafe road conditions that may be encountered by a vehicle during its operation. In many cases, this detection of unsafe road conditions needs to be determined in real-time.

At least some embodiments disclosed herein relate to monitoring data regarding road anomaly events occurring on routes traveled by vehicles. For example, the data can be received from sensors of each of the vehicles or mobile phones. In some embodiments, the sensor data can comprise camera data, video recorder data, audio recorder data, accelerometer data, gyroscope data, vehicle state sensor data, GPS data, outdoor temperature sensor data, moisture sensor data, laser line tracker sensor data, or any other appropriate sensor data.

In some embodiments, sensors that may be mounted onboard standard vehicles can sense road bumps, sudden swerves, or emergency braking. For example, sensors can be based on mobile phones, or embedded in the vehicle, or a hybrid solution using the standard on-board diagnostics (OBD) interface.

In various embodiments, a sensor attached to a vehicle can comprise a speedometer, an accelerator pedal sensor, a brake pedal sensor, an engine revolution per minute (RPM) sensor, an engine temperature sensor, a headlight sensor, an airbag deployment sensor, driver and passenger seat weight sensors, an anti-locking brake sensor, an engine exhaust sensor, a gear position sensor, a cabin equipment operation sensor, or any other appropriate vehicle state sensor.

In some embodiments, a vehicular system equipped with high sensitivity (i.e., high false-positive rate) sensors can receive, collect and aggregate data from all sensors, as it is not required to be as accurate as in the prior art. That is, the disclosed embodiments can utilize low-cost sensors that potentially capture many false-positive signals. In contrast, current approaches require low sensitivity, high-cost sensor networks.

Despite the use of high sensitivity sensors, the current disclosure provides a fast response to transient obstructions to traffic, such as cargo falling off trucks. Due to the high sensitivity of the sensors and low bandwidth and computation requirements with the network, embodiments of the current disclosure can be especially suitable to 5G network deployments, with geographically small cells, and low-latency commutation. In other words, embodiments of the current disclosure can detect road anomaly events, such as potholes and other types of infrastructure decay, opportunistically, using low-cost and numerous sensors mounted or already existing in standard vehicles.

For example, analysis of potential road anomaly event data by the system is used to identify real unsafe road anomaly events. These embodiments provide a technological solution to the above technical problem by analyzing data regarding potential road anomaly events received from other vehicles to identify the real unsafe road anomaly event. In some embodiments, based on this analysis, if the level of confidence in the existence of a road anomaly event is above a predetermined threshold, then the information can be relayed over a communication network to a nearby sensor. For example, this sensor can be embedded in the wireless infrastructure, such as a cellular base station. Once the local aggregator accumulates enough signals, possibly from different vehicles, then the local aggregator can analyze the received data to determine which potential road anomaly events are valid, and then transmit those valid road anomaly event's location and type to a central server. In some embodiments, each such local aggregator can be responsible for a small geographical area, and can be act as a filter of the signals before passing them on to a central obstacle mapping server. For example, the central server can then store those valid road anomaly event's location and type. In some embodiments, the central server can then send information regarding those valid road anomaly event's location and type to other vehicles.

In some embodiments, the central server can take actions based on the characteristics of the road anomaly event. For example, for a minor pothole, it may send a message to the department of public works; for a piece of fallen cargo, it may alert the police department.

For example, road anomaly events may include alien objects that are unsafely positioned on a road. As another example, a tree may have unexpectedly fallen on a road due to a recent storm, and the tree is blocking safe travel on the road.

In some embodiments, the driver can take over certain operations from the vehicle in response to the vehicle receiving a communication that an unsafe location has been identified. One or more cameras of the vehicle, for example, can be used to collect image data that assists in implementing this action. In one example, the vehicle is configured in real-time to respond to the received road anomaly event.

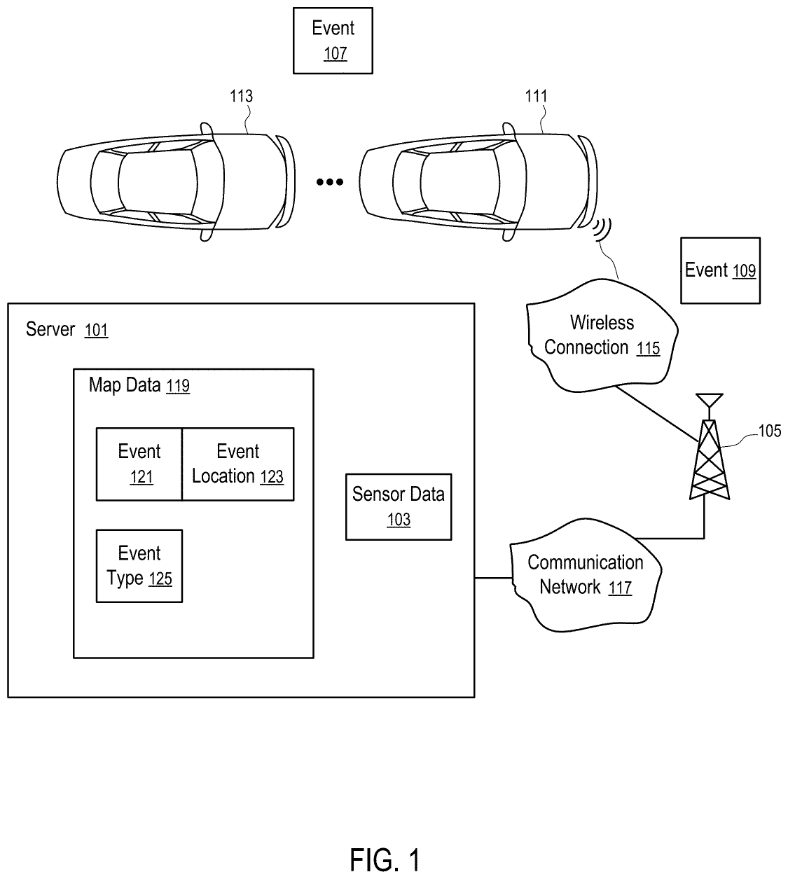

FIG. 1 is a block diagram illustrating a system for receiving data regarding road anomaly events occurring on a plurality of vehicles according to some embodiments of the disclosure. For example, the system of FIG. 1 can include a centralized server 101 in communication with a local aggregator 105 (e.g., 5G base station) through a communication network 117. In some embodiments, the system of FIG. 1 can include a local aggregator 105 in communication with a set of vehicles 111, 113 via a communication network 115. In some embodiments, the communication network 115 can have a low bandwidth and low computation requirements which makes it especially suitable to 5G network deployments, with geographically small cells, and low-latency commutation.

In one embodiment, data regarding road anomaly events (e.g., 107, 109) detected by the sensor attached to vehicle 111 can be received by a local aggregator 105 via wireless connection 115. For example, the received data can include a location for each of the road anomaly events (e.g., 107, 109). For another example, the received data can include an event location 123 and event type 125 for each road anomaly events 121 included in the map data 119. In some embodiments, a road anomaly event 121 can include data such as an identifier, a type of road anomaly event, etc. In other embodiments, the received road anomaly event data can be stored as part of map data 119.

In some embodiments, additional data can be received by server 101 from the vehicles. This can include, for example, data regarding detected road anomaly events such as the event type 121 and the event location 123. This additional data can be stored as part of map data 119. In some embodiments, this additional data can be received from the vehicles.

For example, the road anomaly event data received from the vehicles by a local aggregator 105 can be analyzed. In some embodiments, a local aggregator 105 can receive data regarding potential road anomaly events (e.g., 107, 109) detected by a plurality of sensors through a wireless connection 115. For example, the local aggregator 105 can then analyze the received data to determine which events are actual road anomaly events based on whether the respective road anomaly events are above a predetermined confidence level.

In some embodiments, if the level of confidence of a road anomaly event is above the threshold, then the information regarding the sensor data 103 can be relayed over a communication network 117 to the server 101 by the local aggregator 105. For example, this local aggregator 105 can be embedded in the wireless infrastructure, such as a cellular base station. Once the local aggregator 105 accumulates enough sensor data/signals, possibly from different vehicles (e.g., 111, 113), the local aggregator 105 can determine if the potential road anomaly event is valid. In some embodiments, if the event is valid, the local aggregator 105 then can transmit the sensor data 103 including a road anomaly event's location 123 and type 125 to a central server 101. In some embodiments, each local aggregator 105 can be responsible for a small geographical area and can act as a filter of the signals before passing them on to a central obstacle mapping server 101. For example, the central server 101 can store the event 121, location 123 and type 125 of the anomaly event 121 in the map data 119.

In some embodiments, the local aggregator 105 or the central server 101 can take actions based on the characteristics of the road anomaly event (e.g., 107, 109). For example, for a minor pothole, the local aggregator 105 or the central server 101 may send a message to the department of public works; for a piece of fallen cargo, it may alert the police department.

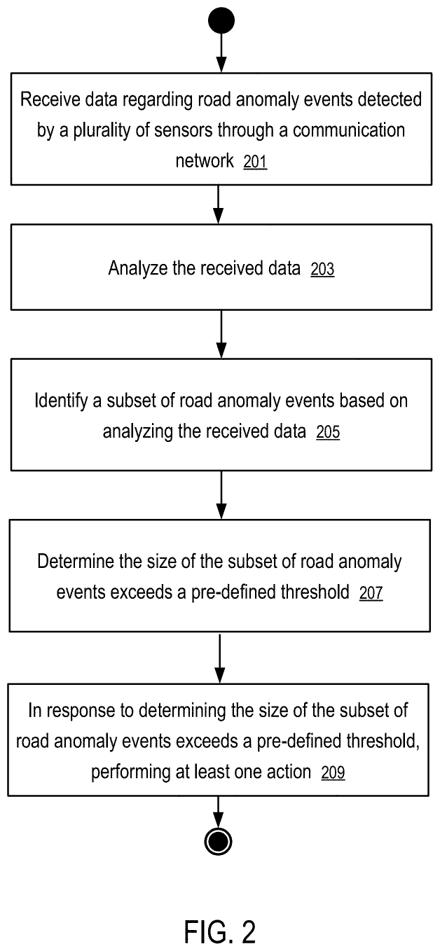

FIG. 2 is a flow diagram illustrating a method for identifying road anomaly events according to some embodiments of the disclosure.

In step 201, according to some embodiments of the disclosure, the method receives data regarding road anomaly events (e.g., 107, 109) detected by a plurality of sensors through a communication network 115. For example, the local aggregator 105 can receive data regarding road anomaly events (e.g., 107, 109) detected by a plurality of sensors through a communication network 115.

As described above, in some embodiments, sensors can be based on mobile phones, or embedded in the vehicle, or a hybrid solution using the standard on-board diagnostics (OBD) interface. In some embodiments, the sensor can comprise a high sensitivity sensor having a high false-positive rate. In some embodiments, the communication network 115 can comprise a low bandwidth network.

For example, a vehicle state sensor can include a speedometer, an accelerator pedal sensor, a brake pedal sensor, an engine revolution per minute (RPM) sensor, an engine temperature sensor, a headlight sensor, an airbag deployment sensor, driver and passenger seat weight sensors, an anti-locking brake sensor, an engine exhaust sensor, a gear position sensor, a cabin equipment operation sensor, or any other appropriate vehicle state sensor. In some embodiments, sensors (e.g., mounted onboard standard vehicles) can sense road bumps, sudden swerves, or emergency brakes.

As described above, in various embodiments, the sensor data can comprise camera data, video recorder data, audio recorder data, accelerometer data, gyroscope data, vehicle state sensor data, GPS data, outdoor temperature sensor data, moisture sensor data, laser line tracker sensor data, or any other appropriate sensor data. In some embodiments, the data also includes the event, the type of the event, and the location of the event. For example, the data can include a location and a type for each of the anomaly events.

As described above, in various embodiments, the road anomaly events (e.g., 107, 109) can include potholes, road bumps, sudden swerves, emergency brakes, cargo falling off trucks, etc. For example, road anomaly events can include a deep pothole in the center of a road, cargo falling off trucks, etc.

As described above, in various embodiments, a communication network can be a wireless connection 115. In some embodiments, the system can include a local aggregator 105 in communication with a set of vehicles 111, . . . , 113 via a wireless communication network 115. For example, the wireless communication network 115 can have a low bandwidth especially suitable to 5G network deployments, with geographically small cells, and low-latency commutation.

As described above, in various embodiments, when the local aggregator 105 receives and accumulates enough signals/data from many vehicles (e.g., 111, 113), the local aggregator can analyze the received data to determine which potential road anomaly events are valid. The local aggregator 105 can then transmit those valid road anomaly event's location and type to a central server or other vehicles. For example, each such local aggregator 105 can be responsible for a small geographical area. That is, it can act as a filter of the signals before passing them on to a central obstacle mapping server 101. For example, the central server 101 can then store those valid road anomaly event 121 associated with its location 123 and type 125 included within the map data 119.

In step 203, according to some embodiments of the disclosure, the method analyzes the received data. For example, as described above, when the local aggregator 105 receives and accumulates enough data from one or more vehicles (e.g., 111, 113), then the local aggregator 105 can analyze the received data to determine which received potential road anomaly event are actual road anomaly event. In some embodiments, as described above, analysis of those potential road anomaly event data can be used to identify real unsafe road anomaly event in step 205.

In step 205, according to some embodiments of the disclosure, the method identifies a subset of real road anomaly events based on analyzing the received data. For example, as described above, after receiving data from one or more vehicles (e.g., 111, 113), the local aggregator 105 can analyze the received data to identify a subset of real road anomaly events. In one embodiment, the local aggregator 105 identifies this subset by determining which received potential road anomaly events are actual road anomaly events. For example, if the level of confidence in the road anomaly event is above a threshold (e.g., a predetermined confidence level), then the local aggregator 105 can identify the existence road anomaly event as a real anomaly event. In some embodiments, sensor data 103 can include a type (125) of the road anomaly event. In other embodiments, sensor data can include a location (123) of the road anomaly event.

In step 207, according to some embodiments of the disclosure, the method determines if the size of the subset of road anomaly events exceeds a pre-defined threshold. For example, as described above, the local aggregator 105 can accumulate real road anomaly events into the subset of road anomaly events. In some embodiments, the local aggregator 105 can further determine whether the size of the subset of road anomaly events exceeds the pre-defined threshold. In some embodiments, the system statically defines this threshold (i.e., a fixed number of events). In other embodiments, the threshold can be determined based on the type of event. For example, a pothole event may have a higher threshold (requiring more events) than a hazardous condition event. In some embodiments, the threshold can be determined based on the determined accuracy of the sensor recording the event. That is, the system may classify some events (e.g., increased braking) as more accurate whereas other events (e.g., pothole detection) may be less accurate. In this scenario, those events that have a high confidence may require fewer samples while lower confidence events may require more.

In step 209, according to some embodiments of the disclosure, in response to determining the size of the subset of road anomaly events exceeds a pre-defined threshold in step 207, the method performs at least one action. For example, as described above, after identifying the existence road anomaly event as a real anomaly event (e.g., the level of confidence in the road anomaly event is above a threshold), the local aggregator 105 can send the information including the sensor data of the identified real road anomaly event to the central sensor 101, public works departments, police departments, etc. based on the characteristics of the road anomaly event (e.g., 107, 109). For example, for a minor pothole, the local aggregator 105 may send a message to the department of public works; for a piece of fallen cargo, the local aggregator 105 may alert the police department.

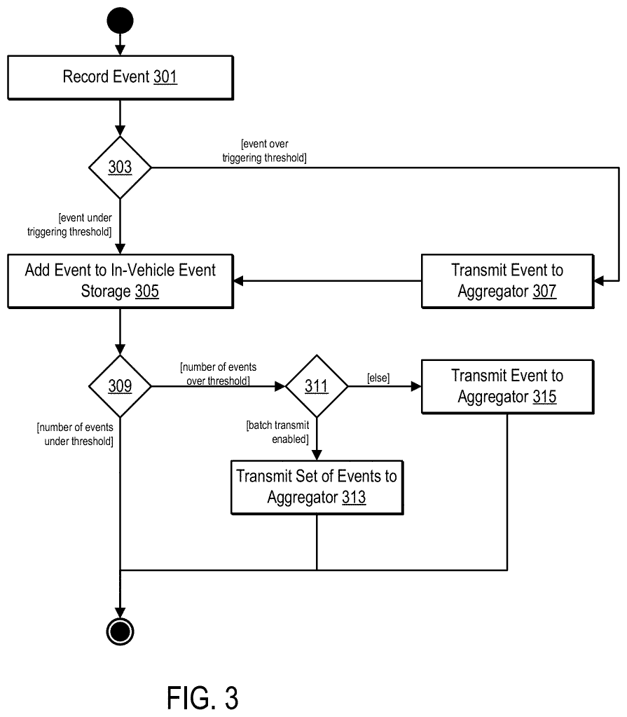

FIG. 3 is a flow diagram illustrating a method for identifying road anomaly events (e.g., 107, 109) according to some embodiments of the disclosure.

In step 301, according to some embodiments of the disclosure, the method records the road anomaly event (e.g., 107, 109) on a vehicle. For example, the method can record the road anomaly event (e.g., 107, 109) on a vehicle via sensors or cameras. For example, sensors or cameras can be based on mobile phones or embedded in the vehicle. Alternatively, the method can use a hybrid solution using the standard on-board diagnostics (OBD) interface of a vehicle. In various embodiments, as mentioned above, a sensor attached to a vehicle can include, but is not limited to, a speedometer sensor, an accelerator pedal sensor, a brake pedal sensor, an engine revolution per minute (RPM) sensor, an engine temperature sensor, a headlight sensor, an airbag deployment sensor, driver and passenger seat weight sensors, an anti-locking brake sensor, an engine exhaust sensor, a gear position sensor, a cabin equipment operation sensor, or any other appropriate vehicle state sensor.

In step 303, according to some embodiments of the disclosure, the method determines if that road anomaly event (e.g., 107, 109) recorded in 301 is over a triggering threshold. For example, the triggering threshold can be a predefined confidence level of the event. For another example, the threshold can be a duration of the road anomaly event.

According to some embodiments of the disclosure, if the method determines that the road anomaly event (e.g., 107, 109) in 301 is under the triggering threshold, in step 305, the method can then add the road anomaly event to an in-vehicle event storage module. For example, the method can classify, in step 305, the received road anomaly event to determine the characteristics of the road anomaly event (e.g., 107, 109). In step 305, according to some embodiments of the disclosure, the method can add each road anomaly event based on the classification. For example, the method can add the road anomaly event based on the type of the road anomaly event. In some embodiments, the method can add the road anomaly event based on the location of the road anomaly event.

According to some embodiments of the disclosure, if the method determines that the road anomaly event (e.g., 107, 109) in 301 is equal to or above the triggering threshold in step 305, in step 307, the method can then transmit the road anomaly event to the local aggregator 105. In some embodiments, after transmitting the road anomaly event to the local aggregator 105, the method can then add the road anomaly event to the in-vehicle event storage in step 305, as described previously.

In step 309, according to some embodiments of the disclosure, after storing the road anomaly event to the in-vehicle event storage in step 305, the method checks to see if the in-vehicle event storage has aggregated enough similar road anomaly events. For example, if the method determines the number of the similar road anomaly events stored in the in-vehicle event storage under a predefined number value of the threshold, the process of the received event ends without further transmitting data to the central server.

For another example, if the method determines the number of the similar events the in-vehicle event storage collected is on or above a predefined number value of the threshold, in step 311, the method determines whether to send the single event in 301 or the entire set of related events to the local aggregator 105 according to a batch setting. In some embodiments, the setting could be configured based on the type of the event, the location of the event, by the designer of the system, or the user's preference, etc.

In step 313, according to some embodiments of the disclosure, the method can transmit the entire related or similar events (including the event detected in step 301) the local aggregator 105 if the setting is in the batch mode. In some embodiments, if the setting is not in the batch mode, in step 315, the method can just transfer the signal 301 event to the local aggregator 105.

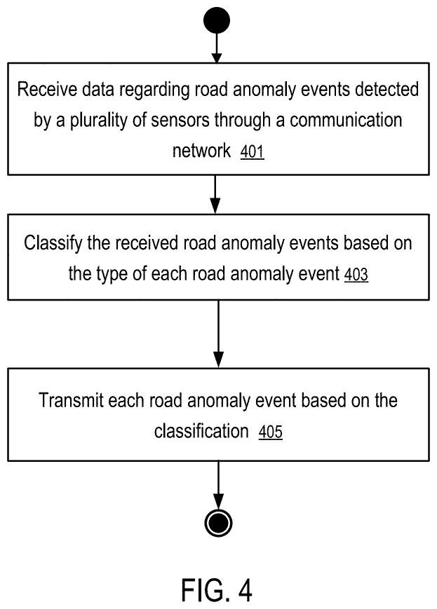

FIG. 4 is a flow diagram illustrating a method for receiving and classifying road anomaly events at a central server based on the type of each road anomaly event (e.g., 107, 109) according to some embodiments of the disclosure.

In step 401, according to some embodiments of the disclosure, the central server 101 can receive data regarding road anomaly events (107, 109) sent from one or more local aggregators 105 through a communication network 117.

For example, as described above, after receiving data from one or more local aggregators 105 receiving data from one or more vehicles (e.g., 111, 113), the central server 101 can classify, in step 403, the received data to determine the characteristics of the road anomaly event (e.g., 107, 109). For example, the received data can include an event location 163 for each the road anomaly event (e.g., 107, 109). The road anomaly event (e.g., 107, 109) can include data such as, for example, an identifier, a type of road anomaly event, etc. In some embodiments, the received road anomaly event data can be stored as part of map data. The method can use an Artificial Neural Network (ANN) model in some embodiments to train and classify data.

In some embodiments, the road anomaly event data received from the local aggregator 105 by server 101 can be analyzed and classified. For example, this analysis can include pattern recognition or other data analysis (e.g., determining a correlation of a road anomaly event data to other data) to determine that the road anomaly events correspond to a pattern or a characteristic classification. For example, event location data 123 can be analyzed and classified to detect a pattern or a characteristic classification. In some embodiments, this characteristic classification or pattern detection can be based at least in part on an output from an artificial neural network model, text analysis, image analysis, etc. or a combination thereof.

Based on the analysis of the received road anomaly event data, a location is identified (e.g., an unsafe road obstacle). For example, the central server 101 can determine that a set of road anomaly events corresponds to a pattern or a characteristic classification; and a corresponding location can be identified based on this determination.

In step 405, according to some embodiments of the disclosure, the central server 101 can transmit each road anomaly event based on the classification. For example, for a minor pothole, the central server 101 can send a message to the department of public works; for a piece of fallen cargo, the central server 101 can alert the police department.

In some embodiments, after the above public works departments, police departments or vehicles receiving the road anomaly event, the above public works departments, police departments or vehicles can then inform the central server 101 if the received road anomaly event is correct or wrong. For example, the above feedback can be used as an input of an artificial neural network model.

In some embodiments, the central server 101 can transmit each road anomaly event via a text message, a phone call, a network communication, a wireless local area network, a cellular communications network, a communication link to a satellite, a communication balloon etc.

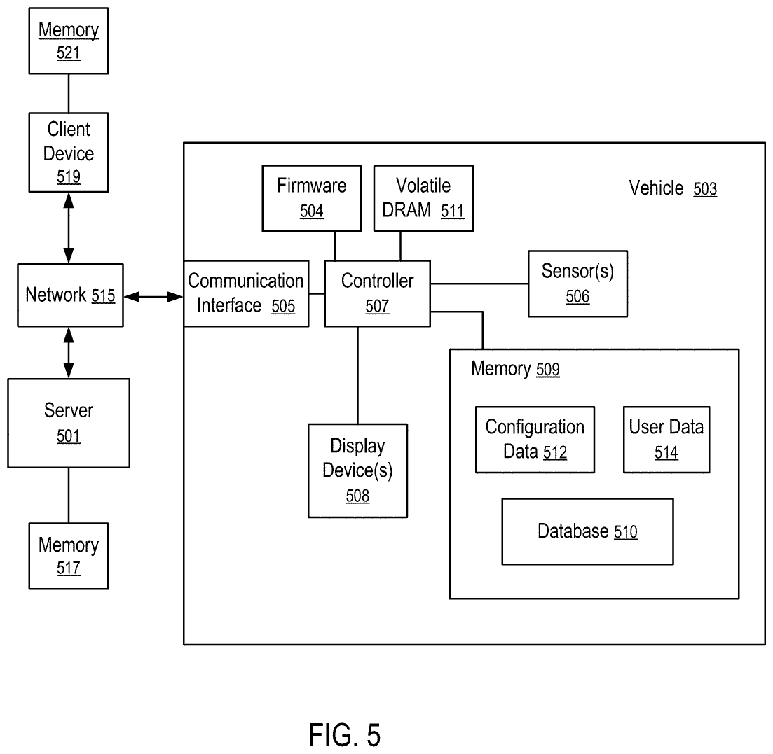

FIG. 5 is a block diagram illustrating a vehicle controlled or configured via a communication interface using a cloud service according to some embodiments of the disclosure.

FIG. 5 shows a vehicle 503 controlled or configured via a communication interface using a cloud service, according to one embodiment. For example, vehicle 503 receives a control communication or is configured in response to a determination by server 501 that vehicle 503 is approaching an unsafe location identified, at least in part, based on road anomaly event data received from other vehicles.

The vehicle 503 includes a communication interface 505 used to receive a configuration update, which is based on analysis of collected road anomaly data. For example, the update can be received from server 501 or client device 519. Communication amongst two or more of the vehicle 503, a server 501, and a client device 519 can be performed over a network 515 (e.g., a wireless network). This communication is performed using communication interface 505.

In one embodiment, the server 501 controls the loading of configuration data (e.g., based on analysis of collected data) of the new configuration into the memory 509 of the vehicle. In one embodiment, data associated with usage of vehicle 503 is stored in a memory 521 of client device 519.

A controller 507 controls one or more operations of the vehicle 503. For example, controller 507 controls user data 514 stored in memory 509. Controller 507 also controls loading of updated configuration data into memory 509 or other memory of the vehicle 503. Controller 507 also controls display of information on display device(s) 508. Sensor(s) 506 provide data regarding operation of the vehicle 503. At least a portion of this operational data can be communicated to the server 501 or the client device 519.

Memory 509 can further include, for example, configuration data 512 or database 510. Configuration data 512 can be, for example, data associated with operation of the vehicle 503 as provided by the server 501. The configuration data 512 can be, for example, based on collected or analyzed road anomaly data (including road anomaly event data received by server 501 from vehicles).

Database 510 can store, for example, configuration data for a user or data collected by sensors 506. Database 510 also can store, for example, navigational maps or other data provided by the server 501.

In one embodiment, when a vehicle is being operated, data regarding road anomaly detection activity of vehicle 503 can be communicated to server 501. This activity may include navigational or other operational aspects of the vehicle 503.

As illustrated in FIG. 5, controller 507 also may control the display of images on one or more display devices 508 (e.g., an alert to the user can be displayed in response to determining by server 501 or controller 507 that vehicle 503 is failing to properly detect road anomaly). Display device 508 can be a liquid crystal display. The controller 507 may receive data collected by one or more sensors 506. The sensors 506 may be, for example, mounted in the vehicle 503. The sensors 506 may include, for example, a camera, a microphone, a motion detector, or a camera.

The sensors 506 may provide various types of data for collection or analysis by the controller 507. For example, the collected data may include image data from the camera or audio data from the microphone. In one embodiment, the image data includes images of one or more new road anomaly encountered by vehicle 503 during travel.

In one embodiment, the controller 507 analyzes the collected data from the sensors 506. The analysis of the collected data includes providing some or all of the road anomaly data to server 501.

In one embodiment, memory 509 stores database 510, which may include data collected by sensors 506 or configuration data received by communication interface 505 from a computing device, such as, for example, server 501. For example, this communication may be used to wirelessly transmit collected data from the sensors 506 to the server 501. The data received by the vehicle may include configuration or other data used to configure control of navigation, display, or other devices by controller 507.

In FIG. 3, firmware 504 controls, for example, the operations of the controller 507. The controller 507 also can, for example, run the firmware 504 to perform operations responsive to communications from the server 501.

The vehicle 503 includes volatile Dynamic Random-Access Memory (DRAM) 511 for the storage of run-time data and instructions used by the controller 507 to improve the computation performance of the controller 507 or provide buffers for data transferred between the server 501 and memory 509. DRAM 511 is volatile.

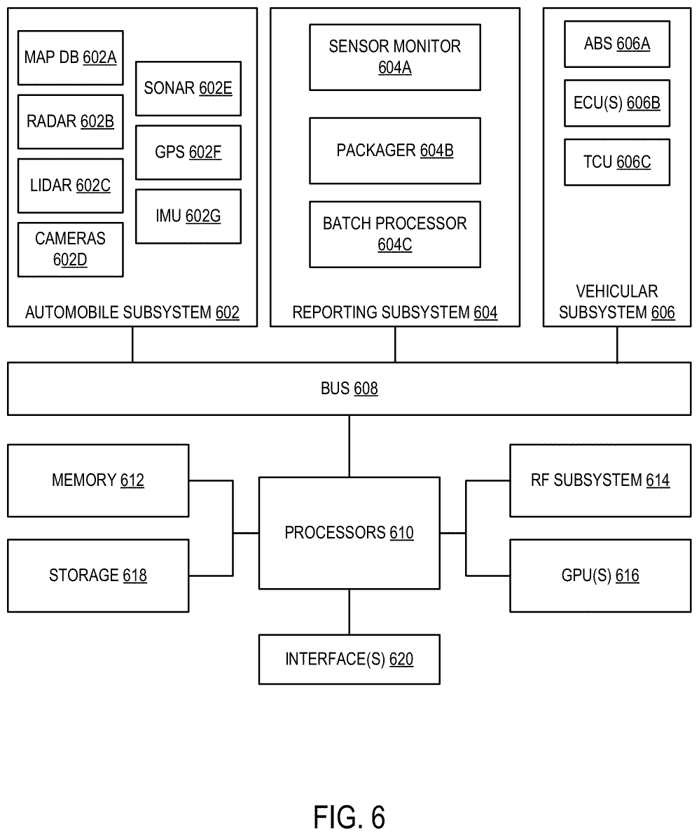

FIG. 6 is a block diagram of a vehicle including one or more various components or subsystems, each of which can be updated in various embodiments to configure the vehicle or perform other actions associated with the vehicle (e.g., configuration or other actions performed in response to identifying a location based on analyzing road anomaly events of a plurality of vehicles). The system illustrated in FIG. 6 may be installed entirely within a vehicle.

The system includes an automobile subsystem 602. In the illustrated embodiment, automobile subsystem 602 includes map database 602A, radar devices 602B, Lidar devices 602C, digital cameras 602D, sonar devices 602E, GPS receivers 602F, and inertial measurement units 602G. Each of the components of automobile subsystem 602 comprise standard components provided in most current vehicles. In one embodiment, map database 602A stores a plurality of high-definition three-dimensional maps used for routing and navigation. Radar devices 602B, Lidar devices 602C, digital cameras 602D, sonar devices 602E, GPS receivers 602F, and inertial measurement units 402G may comprise various respective devices installed at various positions throughout the vehicle as known in the art. For example, these devices may be installed along the perimeter of a vehicle to provide location awareness, collision avoidance, and other standard vehicle functionality.

Vehicular subsystem 606 is additionally included within the system. Vehicular subsystem 606 includes various anti-lock braking systems 606A, engine control units 602B, and transmission control units 602C. These components may be utilized to control the operation of the vehicle in response to the streaming data generated by automobile subsystem 602A. The standard vehicle interactions between automobile subsystem 602 and vehicular subsystem 606 are generally known in the art and are not described in detail herein.

The processing side of the system includes one or more processors 610, short-term memory 612, an RF system 614, graphics processing units (GPUs) 616, long-term storage 618 and one or more interfaces 620.

The one or more processors 610 may comprise central processing units, FPGAs, or any range of processing devices needed to support the operations of the vehicle. Memory 612 comprises DRAM or other suitable volatile RAM for temporary storage of data required by processors 610. RF system 614 may comprise a cellular transceiver or satellite transceiver. Long-term storage 618 may comprise one or more high-capacity solid-state drives (SSDs). In general, long-term storage 618 may be utilized to store, for example, high-definition maps, routing data, and any other data requiring permanent or semi-permanent storage. GPUs 616 may comprise one more high throughput GPU devices for processing data received from automobile subsystem 602A. Finally, interfaces 620 may comprise various display units positioned within the vehicle (e.g., an in-dash screen).

The system additionally includes a reporting subsystem 604 which performs data collection (e.g., collection of data obtained from sensors of the vehicle). The reporting subsystem 604 includes a sensor monitor 604A which is connected to bus 408 and records sensor data transmitted on the bus 608 as well as any log data transmitted on the bus. The reporting subsystem 604 may additionally include one or more endpoints to allow for system components to transmit log data directly to the reporting subsystem 604.

The reporting subsystem 604 additionally includes a packager 604B. In one embodiment, packager 604B retrieves the data from the sensor monitor 604A or endpoints and packages the raw data for transmission to a central system. In some embodiments, packager 604B may be configured to package data at periodic time intervals. Alternatively, or in conjunction with the foregoing, packager 604B may transmit data in real-time and may compress data to facilitate real-time communications with a central system.

The reporting subsystem 604 additionally includes a batch processor 604C. In one embodiment, the batch processor 604C is configured to perform any preprocessing on recorded data prior to transmittal. For example, batch processor 604C may perform compression operations on the data prior to packaging by packager 604B. In another embodiment, batch processor 604C may be configured to filter the recorded data to remove extraneous data prior to packaging or transmittal. In another embodiment, batch processor 604C may be configured to perform data cleaning on the recorded data to conform the raw data to a format suitable for further processing by the central system.

Each of the devices is connected via a bus 608. In one embodiment, the bus 608 may comprise a controller area network (CAN) bus. In some embodiments, other bus types may be used (e.g., a FlexRay or MOST bus). Additionally, each subsystem may include one or more additional busses to handle internal subsystem communications (e.g., LIN busses for lower bandwidth communications).

The present disclosure includes methods and apparatuses which perform the methods described above, including data processing systems which perform these methods, and computer readable media containing instructions which when executed on data processing systems cause the systems to perform these methods.

Each of the server 101 and the computing device of a vehicle 111, . . . , or 113 can be implemented as one or more data processing systems. A typical data processing system may include includes an inter-connect (e.g., bus and system core logic), which interconnects a microprocessor(s) and memory. The microprocessor is typically coupled to cache memory.

The inter-connect interconnects the microprocessor(s) and the memory together and also interconnects them to input/output (I/O) device(s) via I/O controller(s). I/O devices may include a display device or peripheral devices, such as mice, keyboards, modems, network interfaces, printers, scanners, video cameras and other devices known in the art. In one embodiment, when the data processing system is a server system, some of the I/O devices, such as printers, scanners, mice, or keyboards, are optional.

The inter-connect can include one or more buses connected to one another through various bridges, controllers or adapters. In one embodiment the I/O controllers include a USB (Universal Serial Bus) adapter for controlling USB peripherals, or an IEEE-1394 bus adapter for controlling IEEE-1394 peripherals.

The memory may include one or more of: ROM (Read Only Memory), volatile RAM (Random Access Memory), and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In the present disclosure, some functions and operations are described as being performed by or caused by software code to simplify description. However, such expressions are also used to specify that the functions result from execution of the code/instructions by a processor, such as a microprocessor.

Alternatively, or in combination, the functions and operations as described here can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While one embodiment can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory or cache. Portions of this software or data may be stored in any one of these storage devices. Further, the data and instructions can be obtained from centralized servers or peer to peer networks. Different portions of the data and instructions can be obtained from different centralized servers or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to non-transitory, recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROM), Digital Versatile Disks (DVDs), etc.), among others. The computer-readable media may store the instructions.

The instructions may also be embodied in digital and analog communication links for electrical, optical, acoustical or other forms of propagated signals, such as carrier waves, infrared signals, digital signals, etc. However, propagated signals, such as carrier waves, infrared signals, digital signals, etc. are not tangible machine readable medium and are not configured to store instructions.

In general, a machine readable medium includes any mechanism that provides (i.e., stores or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

The above description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

For the purposes of this disclosure a module is a software, hardware, or firmware (or combinations thereof) system, process or functionality, or component thereof, that performs or facilitates the processes, features, or functions described herein (with or without human interaction or augmentation). A module can include sub-modules. Software components of a module may be stored on a computer-readable medium for execution by a processor. Modules may be integral to one or more servers, or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example to provide a complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
receiving, by a processor, data regarding potential road anomaly events detected by a plurality of sensors in a communication network;
identifying, by the processor, a subset of the road anomaly events, each event in the subset of road anomaly events associated with a confidence level exceeding a pre-defined threshold;
identifying, by the processor, a confirmed road anomaly event based on the subset of road anomaly events; and
sending, by the processor, at least one communication associated with the confirmed road anomaly event to a computing device based on a type of the confirmed road anomaly event.

2. The method of claim 1, the receiving data regarding potential road anomaly events comprising receiving high sensitivity road anomaly measurements from the plurality of sensors.

3. The method of claim 1, the receiving data regarding potential road anomaly events comprising receiving a location and type of each of the potential road anomaly events.

4. The method of claim 1, the identifying the subset of the road anomaly events further comprising clustering the road anomaly events based on a matching type for each of the road anomaly events.

5. The method of claim 1, the identifying the confirmed road anomaly event comprising determining that a size of the subset exceeds a second pre-defined threshold.

6. The method of claim 1, the road anomaly events comprising road bumps, sudden swerves, emergency brakes, cargo falling off trucks or a combination thereof.

7. The method of claim 1, the sending the at least one communication comprising transmitting an alert to an emergency services computing device.

8. A device comprising:
a processor; and
a storage medium for tangibly storing thereon program logic for execution by the processor, the stored program logic comprising:
logic for receiving, by the processor, data regarding potential road anomaly events detected by a plurality of sensors in a communication network,
logic for identifying, by the processor, a subset of the road anomaly events, each event in the subset of road anomaly events associated with a confidence level exceeding a pre-defined threshold,
logic for identifying, by the processor, a confirmed road anomaly event based on the subset of road anomaly events, and
logic for sending, by the processor, at least one communication associated with the confirmed road anomaly event to a computing device based on a type of the confirmed road anomaly event.

9. The device of claim 8, the receiving data regarding potential road anomaly events comprising receiving high sensitivity road anomaly measurements from the plurality of sensors.

10. The device of claim 8, the receiving data regarding potential road anomaly events comprising receiving a location and type of each of the potential road anomaly events.

11. The device of claim 8, the identifying the subset of the road anomaly events further comprising clustering the road anomaly events based on a matching type for each of the road anomaly events.

12. The device of claim 8, the identifying the confirmed road anomaly event comprising determining that a size of the subset exceeds a second pre-defined threshold.

13. The device of claim 8, the road anomaly events comprising road bumps, sudden swerves, emergency brakes, cargo falling off trucks or a combination thereof.

14. The device of claim 8, the sending the at least one communication comprising transmitting an alert to an emergency services computing device.

15. A non-transitory computer-readable storage medium for tangibly storing computer program instructions capable of being executed by a computer processor, the computer program instructions defining the steps of:
receiving, by the processor, data regarding potential road anomaly events detected by a plurality of sensors in a communication network;
identifying, by the processor, a subset of the road anomaly events, each event in the subset of road anomaly events associated with a confidence level exceeding a pre-defined threshold;
identifying, by the processor, a confirmed road anomaly event based on the subset of road anomaly events; and
sending, by the processor, at least one communication associated with the confirmed road anomaly event to a computing device based on a type of the confirmed road anomaly event.

16. The non-transitory computer-readable storage medium of claim 15, the receiving data regarding potential road anomaly events comprising receiving high sensitivity road anomaly measurements from the plurality of sensors.

17. The non-transitory computer-readable storage medium of claim 15, the receiving data regarding potential road anomaly events comprising receiving a location and type of each of the potential road anomaly events.

18. The non-transitory computer-readable storage medium of claim 15, the identifying the subset of the road anomaly events further comprising clustering the road anomaly events based on a matching type for each of the road anomaly events.

19. The non-transitory computer-readable storage medium of claim 15, the identifying the confirmed road anomaly event comprising determining that a size of the subset exceeds a second pre-defined threshold.

20. The non-transitory computer-readable storage medium of claim 15, the road anomaly events comprising road bumps, sudden swerves, emergency brakes, cargo falling off trucks or a combination thereof.
